(19) United States
(12) Patent Application Publication
(10) Pub. No.: US 2025/0036715 A1
(43) Pub. Date: Jan. 30, 2025

(54) DATA PROCESSING DEVICE, DATA PROCESSING METHOD, AND DATA PROCESSING PROGRAM

(71) Applicant: NIPPON TELEGRAPH AND TELEPHONE CORPORATION, Tokyo (JP)

(72) Inventors: Saki HATTA, Tokyo (JP); Hiroyuki UZAWA, Tokyo (JP); Shuhei YOSHIDA, Tokyo (JP); Yuko IINUMA, Tokyo (JP); Yuya OMORI, Tokyo (JP); Daisuke KOBAYASHI, Tokyo (JP); Ken NAKAMURA, Tokyo (JP)

(73) Assignee: NIPPON TELEGRAPH AND TELEPHONE CORPORATION, Tokyo (JP)

(21) Appl. No.: 18/715,083

(22) PCT Filed: Dec. 3, 2021
(86) PCT No.: PCT/JP2021/044555

§ 371 Date: May 30, 2024

(51) Int. Cl. G06F 17/15

(52) U.S. Cl. CPC G06F 17/15

(57) ABSTRACT

There is provided a data processing device 10 that performs a convolution operation of two pieces of input data of 2^{M}×N bits (N is a positive integer and M is a natural number) width with a minimum accuracy of the convolution operation being N bits, and performs processing corresponding to a plurality of the consecutive M, the data processing device 10 including: a product-sum operation unit 101 that performs a product-sum operation according to the value of M; a shifter 102 that performs shift processing on a result of a product-sum operation of the product-sum operation unit 101 in a case where the value of M is not 0; an addition unit 103 that performs addition processing on each output of the shifter 102 or the product-sum operation unit 101 according to the value of M; a selector 105 that selects an output from the addition unit 103 according to the value of M; a cumulative addition unit 106 that cumulatively adds the outputs from the selector 105; and a cumulative addition memory 107 that stores outputs from the cumulative addition unit 106 in a process of a convolution operation.

### TECHNICAL FIELD

The technology of the disclosure relates to a data processing device, a data processing method, and a data processing program.

### BACKGROUND ART

A convolutional neural network (CNN) is mainly used for image recognition, and includes a “convolution layer” that performs a “convolution operation” to extract a feature amount of an input image. In recent years, You Only Look Once (YOLO), which is an object detection algorithm based on a CNN, a pose estimation algorithm OpenPose, and the like have been disclosed (Non Patent Literature 1 and 2), and application to an edge AI system requiring real-time performance such as a monitoring camera installed in automatic driving or a drone has been studied. It is assumed that these systems require different convolution operation accuracy for each application, and it is required to realize high performance and size reduction while having a mechanism capable of switching the accuracy in one system.

Therefore, for example, Non Patent Literature 3 discloses a processing method for realizing three types of convolution operation accuracy of 4 bits, 8 bits, and 16 bits by a shared circuit.

### CITATION LIST

### Non Patent Literature

Non Patent Literature 1: Joseph Redmon. Ali Farhadi, “YOLOv3: An Incremental Improvement”, https://arxiv.org/abs/1804.02767
Non Patent Literature 2: Zhe Cao et al., “Realtime Multi-Person 2D Pose Estimation using Part Affinity Fields” https://arxiv.org/pdf/1611.08050.pdf
Non Patent Literature 3: Hao Zhang et al., “New Flexible Multiple-Precision Multiply-Accumulate Unit for Deep Neural Network Training and Inference”

### SUMMARY OF INVENTION

### Technical Problem

In the processing method disclosed in Non Patent Literature 3, since the blocks are input in parallel, the input bus width of iFmap increases as the number of parallel blocks increases. In the case of application to the edge AI system, since the bus width is limited, the number of parallel pixels is doubled in the 8-bit mode such that the bus width in the 16-bit mode is not changed in the processing method disclosed in Non Patent Literature 3. As a result, a product-sum operation circuit that should have been originally used is in an empty state, and the processing method cannot extract sufficient performance for the number of product-sum operators prepared in advance.

Specifically, the operator utilization efficiency in the 8-bit mode decreases to 50% as compared with that in the 16-bit mode, and decreases to 25% in the 4-bit mode. In order to set the operator utilization efficiency to 100% using the processing method disclosed in Non Patent Literature 3, it is necessary to double both the iFmap input bus width and the kernel input bus width in the 8-bit mode, and to quadruple both the iFmap input bus width and the kernel input bus width in the 4-bit mode.

Due to the large scale and complexity of the CNN model, many multi-core configurations have been considered in recent hardware, and an increase in both the iFmap input bus width and the kernel input bus width per core by 2 to 4 times has a large impact on a circuit area. In particular, since the iFmap size is larger than the kernel size, doubling the input bus width for supplying iFmap from the stored memory has a great impact on the circuit size. Furthermore, Non Patent Literature 3 does not describe in detail a specific configuration capable of switching plural types of convolution operation accuracy, and has a high installation difficulty level.

The technology of the disclosure has been made in view of the above points, and an object thereof is to provide a data processing device, a data processing method, and a data processing program that increase utilization efficiency of a product-sum operation circuit while minimizing circuit resources and support plural types of convolution operation accuracy.

### Solution to Problem

According to a first aspect of the present disclosure, there is provided a data processing device that performs a convolution operation of two pieces of input data of 2^{M}×N bits (N is a positive integer and M is a natural number) width with a minimum accuracy of the convolution operation being N bits, and performs processing corresponding to a plurality of the consecutive M, the data processing device including: a product-sum operation unit that performs a product-sum operation according to the value of M; a shifter that performs shift processing on a result of the product-sum operation of the product-sum operation unit in a case where the value of M is not 0; an addition unit that performs addition processing on each output of the shifter or the product-sum operation unit according to the value of M; a selector that selects an output from the addition unit according to the value of M; a cumulative addition unit that cumulatively adds the outputs from the selector; and a cumulative addition memory that stores outputs from the cumulative addition unit in a process of a convolution operation.

According to a second aspect of the present disclosure, there is provided a data processing method for performing a convolution operation of two pieces of input data of 2^{M}×N bits (N is a positive integer and M is a natural number) width with a minimum accuracy of the convolution operation being N bits, and performing processing corresponding to a plurality of the consecutive M, in which a computer executes processing of performing a product-sum operation according to the value of M, performing shift processing on a result of the product-sum operation in a case where the value of M is not 0, performing addition processing on a result of the shift processing or a result of the product-sum operation according to the value of M, selecting an output of the addition processing according to the value of M, cumulatively adding the selected outputs, and storing a result of the cumulative addition in a process of a convolution operation.

According to a third aspect of the present disclosure, there is provided a data processing program that performs a convolution operation of two pieces of input data of 2^{M}×N bits (N is a positive integer and M is a natural number) width with a minimum accuracy of the convolution operation being N bits, and performing processing corresponding to a plurality of the consecutive M, the data processing program causing a computer to execute processing of performing a product-sum operation according to the value of M, performing shift processing on a result of the product-sum operation in a case where the value of M is not 0, performing addition processing on a result of the shift processing or a result of the product-sum operation according to the value of M, selecting an output of the addition processing according to the value of M, cumulatively adding the selected outputs, and storing a result of the cumulative addition in a process of a convolution operation.

### Advantageous Effects of Invention

According to the technology of the disclosure, it is possible to provide a data processing device, a data processing method, and a data processing program that increase utilization efficiency of a product-sum operation circuit while minimizing circuit resources and support plural types of convolution operation accuracy.

### BRIEF DESCRIPTION OF DRAWINGS

FIG. 1 is a diagram illustrating a general three-dimensional convolution operation method.

FIG. 2A is a diagram illustrating a processing method in units of one pixel.

FIG. 2B is a diagram illustrating a processing method in units of one pixel.

FIG. 3 is a diagram illustrating a data processing method according to a first embodiment of the present disclosure.

FIG. 4 is a diagram illustrating a data processing method according to the first embodiment of the present disclosure.

FIG. 5 is a block diagram illustrating a hardware configuration of a data processing device.

FIG. 6 is a block diagram illustrating an example of a functional configuration of the data processing device.

FIG. 7 is a diagram illustrating an example of processing using a 4-bit operator.

FIG. 8 is a flowchart illustrating a flow of data processing by a data processing device.

FIG. 9 is a diagram illustrating a data processing method according to a second embodiment of the present disclosure.

### DESCRIPTION OF EMBODIMENTS

Hereinafter, an example of an embodiment of the disclosed technology will be described with reference to the drawings. Note that the same or equivalent components and parts will be given the same reference numerals in each of the drawings. Moreover, dimensional ratios in the drawings are exaggerated for convenience of description and thus may be different from actual ratios.

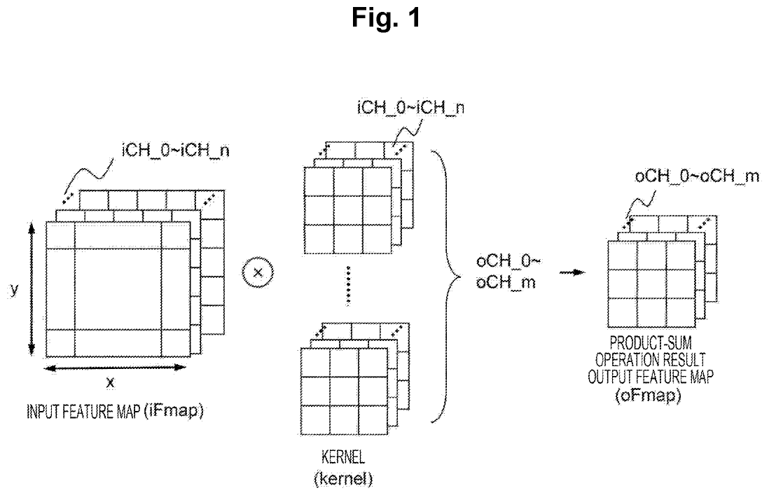

First, a general three-dimensional convolution operation method will be described. FIG. 1 is a diagram illustrating a general three-dimensional convolution operation method. The input data is assumed to be, for example, video data. In a certain layer of the network model, a product-sum operation of each kernel for n channels as weights is performed on an input feature map (iFmap) of n channels in a case where the number of input channels is n>an integer of n>0). In a case where the number of output channels is m (an integer of m>0), an m-channel output feature map (oFmap) is generated by repeating the product-sum operation for m channels.

The obtained oFmap of the m channels is the iFmap of the next layer. In the case of the first layer, the video data is not iFmap but input video data, and the input channels are generally three channels of RGB. In a case where the above processing is realized by general hardware, when it is designed to read iFmap from a memory stored in one cycle, the memory and the wiring are designed according to the data amount of the largest size (x and y in whichx×y in FIG. 1 is maximum) throughout, and the circuit scale increases. In order to avoid an increase in circuit scale, a method is adopted in which the maximum value of iFmap is divided into several blocks, iFmap is input for each block, the convolution operation is performed, and output is performed.

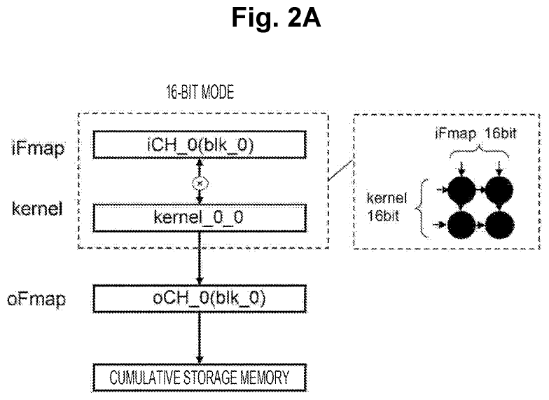

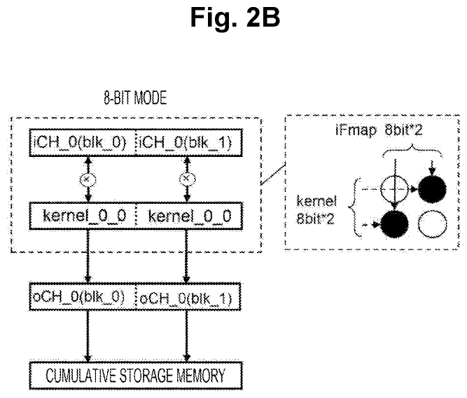

FIGS. 2A and 2B are diagrams illustrating a processing method in units of one pixel using the technology disclosed in Non Patent Literature 3. As the product-sum operation circuit that performs the convolution operation, a product-sum operation circuit corresponding to the maximum value (for example, 16 bits) of the operation mode is prepared, and even in a case where the convolution operation is performed in the 8-bit mode and the 4-bit mode, the same product-sum operation circuit is used and it is not necessary to individually have a circuit for each mode. In FIGS. 2A and 2B, black circles indicate a state where an 8-bit product-sum operator is used, and white circles indicate a state where an 8-bit product-sum operator is not used.

In the case of the 16-bit mode, a product-sum operation of an input pixel block (blk_1, 1 is a block number, 1>0) obtained by dividing iFmap into a plurality of parts and kernel is executed using all the operators as illustrated in FIG. 2A and stored in a cumulative storage memory as an intermediate result of oFmap. This processing is repeatedly and cumulatively added to the number of blocks and the number of input channels (iCH_n, n is the maximum input channel) according to the size of iFmap to generate oFmap corresponding to the output channel (oCH_m, m is the maximum output channel).

In the case of the 8-bit mode, as illustrated in FIG. 2B, the number of blocks is input twice (two pixels when focusing on one pixel), and 2 blocks are executed in parallel to double the processing speed. Similarly, in the 4-bit mode, the processing method in which 4 processes are executed in parallel is adopted.

As described above, in the case of using the technology disclosed in Non Patent Literature 3, since the blocks are input in parallel, the input bus width of iFmap increases as the number of parallel blocks increases. In the processing method disclosed in Non Patent Literature 3, the number of parallel pixels is doubled in 8-bit mode such that the bus width in 16-bit mode is not changed. As a result, as illustrated in FIG. 2B, the product-sum operator that should have been originally used is in an empty state, and the processing method cannot extract sufficient performance for the number of product-sum operators prepared in advance.

### First Embodiment

Next, a first embodiment of the present disclosure will be described. In the first embodiment of the present disclosure, circuit resources capable of realizing the highest accuracy among plural types of convolution operation accuracy are provided, an operator with the lowest accuracy is used as a minimum unit, and both the low operation accuracy and the high accuracy convolution operation are realized by combining the operators. In a case other than the highest convolution operation accuracy, performance in the low accuracy mode can be enhanced while minimizing circuit resources by performing parallel processing for each iCH and oCH.

In the first embodiment, when the minimum convolution operation accuracy of iFmap and kernel is N bits (N is an integer larger than 0), a technology capable of supporting plural types of convolution operation accuracy in which any M is continuous in 2^{M}×N bits (M=0, 1, 2 . . . ) is provided. Here, in order to avoid complexity of description, as an example, a processing method and a configuration thereof that can support a case where the minimum convolution operation accuracy is N=8, M=0, and 1 (8 bits or 16 bits) will be described.

First, a processing method in a 16-bit mode using an 8-bit operator will be described. In the 16-bit processing, data obtained by dividing 16 bit data of iFmap[15:0] and kernel[15:0] into 8 high-order bits (iFmap[15:81 kernel[15:8]) and 8 low-order bits (iFmap[7:0] kernel[7:0]) is used to realize an operation of iFmap|15:0]*kernel[15:01].

The reason why iFmap[15:0]*kernel[15:0] can be operated by being divided into high order and low order will be described. iFmap[15:0]*kernel[15:01] can be expanded as follows. In the following Formula (1), “<<8 bit” means that the shift is performed to the left by 8 bits.

$$iFmap [ 15 : 0 ] * kernel [ 15 : 0 ] = ( iFmap [ 15 : 8 \vert << 8bit + iFmap [ 7 : 0 ] ) * ( kernel [ 15 : 8 ] << 8bit + kernel [ 7 : 0 ] ) \qquad ( 1 )$$

Since the shift to the left by 8 bits is multiplied by 2⁸, when iFmap[15:81]=iCH(h), iFmap[7:01]=iCH(1), kernel[15:81]=kernel(h), and kernel[7:0]=kernel(l) in the above Formula (1), Formula (1) is as follows.

$$( iCH ( h ) * 2 ⋀ 8 + iCH ( 1 ) ) * ( kernel ( h ) * 2 ⋀ 8 + kernel ( 1 ) ) = 2 ⋀ 8 ⋀ 2 * iCH ( h ) * kernel ( h ) + 2 ⋀ 8 * ( iCH ( h ) * kernel ( 1 ) + iCH ( 1 ) * kernel ( h ) ) + iCH ( 1 ) * kernel ( 1 ) \qquad ( 2 )$$

From the above, it can be seen that a 16-bit operation can be performed using high-order data and low-order data of iFmap and kernel and four operators.

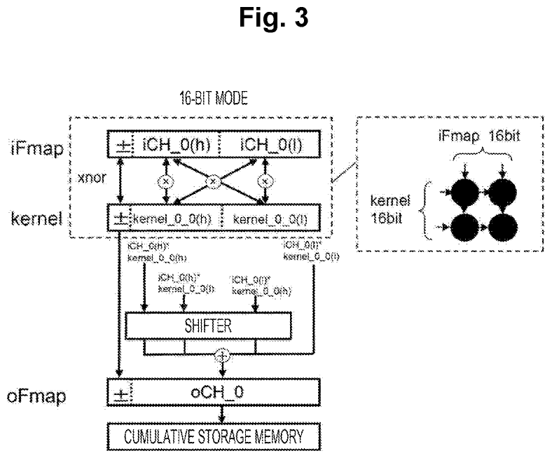

FIG. 3 is a diagram illustrating a data processing method according to the first embodiment of the present disclosure. FIG. 3 illustrates a data processing method in a 16-bit mode. A black circle in FIG. 3 indicates a state where an 8-bit operator that is a minimum operator unit is used. Since the 16-bit mode processing is reference processing, parallel processing is not performed, and an intermediate result of the oCH is calculated using a kernel corresponding to the iCH for one iCH and stored in the cumulative storage memory. This processing is repeated up to iCH, and a result for one oCH can be obtained.

In the convolution operation, since data with a sign is generally operated, the 1 high-order bit is assigned to the sign. The 16-bit operation in which the high-order data and the low-order data are combined does not need to consider a sign. Therefore, the processing represented by Formula (2) is performed using the high-order data and the low-order data excluding the most significant bits of the iCH and the kernel, the highest-order sign bit of iCH and the highest-order significant sign bit of kernel are subjected to the xnor operation, and accordingly, the final sign is output.

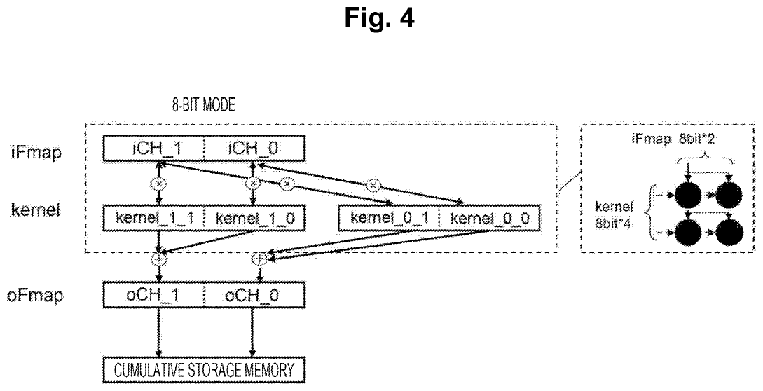

Next, a data processing method in the 8-bit mode will be described with reference to FIG. 4. In a case where there is a resource of an operator capable of 16-bit processing and the utilization efficiency of the operator is 100%, performance of up to 4 times is obtained at the time of 8-bit processing as compared with that at the time of 16-bit processing. In the parallel processing method according to the present embodiment, 2 iCHs and 2 oCHs are used, 2 iCHs are processed in parallel at the same time, 2 oCHs are operated in parallel at the same time, and accordingly, 4 times the performance is achieved. Although it is necessary to double the supply amount of kernel in order to operate 2 oCHs in parallel at the same time, since iCHs are 2 parallel and the bit width is half, the iFmap input bus width is the same as that at the time of 16-bit processing.

Next, a specific processing method in the 8-bit mode will be described. In order to input 2 iCHs in parallel at the same time, data of an odd iCH is set in 8 high-order bits and data of an even iCH is set in 8 low-order bits in an input bus width of 16 bits in FIG. 4. A kernel corresponding to the iCH and the oCH is set, and a product-sum operation is performed. In FIG. 4, kernel_o_i (o: oCH number, i: iCH number, o i>0) indicates data corresponding to iCH and oCH, respectively. At the time of the product-sum operation, four operators corresponding to each of the inputs of the two iCHs and the outputs of the two oCHs are required, and all these operators can be used. After the kernel product-sum operation, a result obtained by adding a term common to oCH and adding a product-sum operation result of iCH_0 and iCH_1 is stored in the cumulative storage memory as an intermediate result of oCH_0 and oCH_1, respectively. In FIG. 4, iCH_0*kernel_0_0 and iCH_1*kernel_0_1, iCH_0*kernel_1_0, and iCH_1*kernel_1_1 are stored in the cumulative storage memory. The product-sum operation and the storage in the cumulative storage memory are repeatedly and cumulatively added for the maximum number of iCHs to obtain the final results of oCH_0 and oCH_1. By repeating the above processing for the maximum number of oCHs, the results of all oCHs can be obtained.

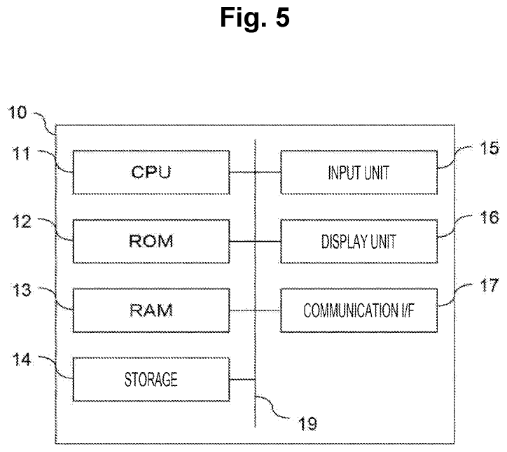

Next, a hardware configuration example of a data processing device that executes the convolution operation processing according to the first embodiment of the present disclosure will be described. FIG. 5 is a block diagram illustrating a hardware configuration of a data processing device 10. As illustrated in FIG. 5, the data processing device 10 includes a central processing unit (CPU) 11, a read only memory (ROM) 12, a random access memory (RAM) 13, a storage 14, an input unit 15, a display unit 16, and a communication interface (1/F) 17. The components are communicatively connected to each other via a bus 19.

The CPU 11 is a central processing unit, which executes various programs and controls each unit. That is, the CPU 11 reads a program from the ROM 12 or the storage 14, and executes the program using the RAM 13 as a work area. The CPU 11 performs control of each of the components described above and various types of calculation processing according to a program stored in the ROM 12 or the storage 14. In the present embodiment, the ROM 12 or the storage 14 stores a data processing program for executing a convolution operation processing.

The ROM 12 stores various programs and various types of data. The RAM 13 serving as a work area temporarily stores programs or data. The storage 14 is configured with a storage device such as a hard disk drive (HDD) or a solid state drive (SSD), and stores various programs including an operating system and various types of data.

The input unit 15 includes a pointing device such as a mouse and a keyboard, and is used to perform various inputs.

The display unit 16 is, for example, a liquid crystal display and displays various types of information. The display unit 16 may function as the input unit 15 by adopting a touch panel system.

The communication interface 17 is an interface for communicating with other equipment. For the communication, for example, a wired communication standard such as Ethernet (registered trademark) or FDDI, or a wireless communication standard such as 4G, 5G, or Wi-Fi (registered trademark) is used.

Next, a functional configuration of the data processing device 10 will be described.

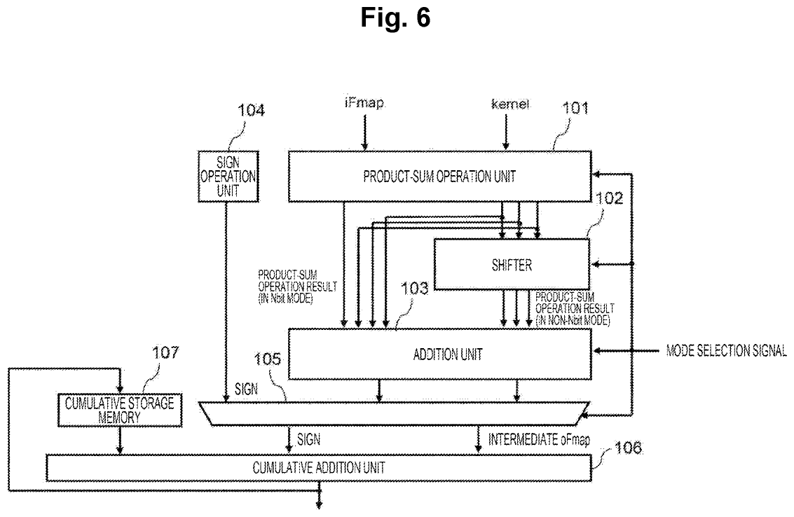

FIG. 6 is a block diagram illustrating an example of a functional configuration of the data processing device 10. As illustrated in FIG. 6, the processing device 10 includes a product-sum operation unit 101, a shifter 102, an addition unit 103, a sign operation unit 104, a selector 105, a cumulative addition unit 106, and a cumulative storage memory 107 as functional configurations. Each functional configuration is realized by the CPU 11 reading a data processing program stored in the ROM 12 or the storage 14, developing the data processing program in the RAM 13, and executing the data processing program.

Operations of the product-sum operation unit 101, the shifter 102, the addition unit 103, and the selector 105 are changed according to a mode selection signal set from external software or the like. The mode selection signal selects accuracy. In other words, the operations of the product-sum operation unit 101, the shifter 102, the addition unit 103, and the selector 105 change according to the value of M.

The product-sum operation unit 101 performs a product-sum operation with plural types of convolution operation accuracy according to the value of M.

In a case where M is not 0, that is, in a case where the product-sum operation by the product-sum operation unit 101 is not the minimum accuracy, the shifter 102 performs shift processing on the result of the product-sum operation by the product-sum operation unit 101.

In a case where M is 0, that is, in a case where the product-sum operation by the product-sum operation unit 101 has the minimum accuracy, the shifter 102 does not perform the shift processing.

The addition unit 103 performs addition processing on the result of the product-sum operation by the product-sum operation unit 101. In a case where M is not 0, that is, in a case where the product-sum operation by the product-sum operation unit 101 is not the minimum accuracy, the addition unit 103 performs addition processing on the result of the product-sum operation that has been shifted by the shifter 102. When the product-sum operation by the product-sum operation unit 101 has the minimum accuracy, the addition unit 103 performs addition processing on the result of the product-sum operation by the product-sum operation unit 101.

The sign operation unit 104 calculates the sign when M is not 0, that is, when the calculation is not the calculation with the minimum accuracy. Specifically, in a case where the operation is not the operation with the minimum accuracy, the sign operation unit 104 performs an xnor operation on the highest-order sign bit of iCH and the highest-order sign bit of kernel to operate the sign. The selector 105 selects an output according to the mode selected based on the mode selection signal and outputs the selected output to the cumulative addition unit 106.

The cumulative addition unit 106 cumulatively adds oFmap in the middle of being obtained in the process of the convolution operation, and stores the oFmap in the cumulative storage memory 107. The cumulative storage memory 107 stores oFmap cumulatively added by the cumulative addition unit 106. The product-sum operation in the product-sum operation unit 101 and the storage in the cumulative storage memory 107 are repeatedly and cumulatively added for the maximum number of iCHs to obtain the final results of oCH_0 and oCH_1. The data processing device 10 can obtain results of all oCHs by repeating the above processing for a maximum number of oCHs.

Operations of the product-sum operation unit 101 and the addition unit 103 differ depending on a mode selection signal set from external software or the like. For example, in the case of N=8 which is the minimum accuracy, the product-sum operation unit 101 processes 2 pieces of iCH data in parallel at the same time by the same processing method as the processing method in the 8-bit mode described above, and the addition unit 103 adds the iCH data to obtain a result corresponding to 2 oCHs. In the case of N=16, the product-sum operation unit 101 performs a product-sum operation using each of the 8 high-order bit data and the 8 low-order bit data of iCH and kernel by a processing method similar to the processing method in the 16-bit mode described above, and outputs data other than the product-sum operation of the 8 low-order bits to the shifter 102. The shifter 102 performs bit shift according to the accuracy and the operation result term. The addition unit 103 adds the data shifted by the shifter 102 and the data of the product-sum operation of the 8 low-order bits, and outputs the result to the cumulative addition unit 106 as an intermediate result of one oCH. After the output of the cumulative addition unit 106, the same processing as in the 8-bit mode is performed and output to the cumulative storage memory 107.

In the present embodiment, the processing in the case of corresponding to the case of 8 bits and the case of 16 bits has been described, but the present disclosure is not limited to these two cases. For example, it is also possible to correspond to three or more types of convolution operation accuracy such as 4 bits, 8 bits, and 16 bits. Even in the case of corresponding to the three modes, the operator of the minimum unit is a 4-bit operator having the lowest operation accuracy, and the operator resource is prepared by an amount capable of 16-bit processing. In the 4-bit mode, performance of up to 16 times can be realized as compared with the 16-bit mode.

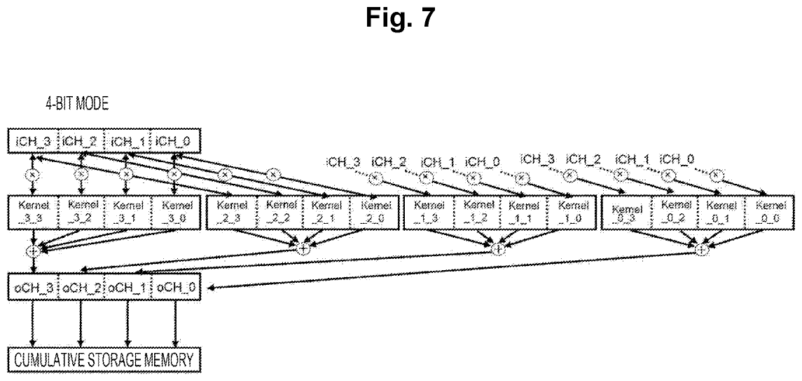

FIG. 7 is a diagram illustrating an example of processing using a 4-bit operator. As illustrated in FIG. 7, the performance in this case can be realized by preparing 4 times the kernel supply amount and performing 4 iCH processing in parallel and 4 oCH processing in parallel. On the other hand, in a case where it is not necessary to set the performance to 16 times, it is possible to realize the 4-bit mode processing with the kernel supply amount twice that in the 8-bit mode by performing 2 iCH processing in parallel and 2 oCH processing in parallel.

The number of convolution operation modes of the present embodiment and the parallel numbers of the iCH processing and the oCH processing are generalized as follows. 2^{Mmax} is a coefficient to be multiplied by N of the mode at the highest operation accuracy.
Operator resource: 2^{Mmax}×N-bit processable amount
Minimum operator unit: N bits
Adjust iCH parallel number and oCH parallel number such that iCH parallel number*oCH parallel number=(2^{Mmax}×N)/(2M×N) is satisfied

The data processing device 10 according to the present embodiment can minimize circuit resources while maximizing the product-sum operator utilization efficiency inside hardware.

Next, actions of the data processing device 10 will be described.

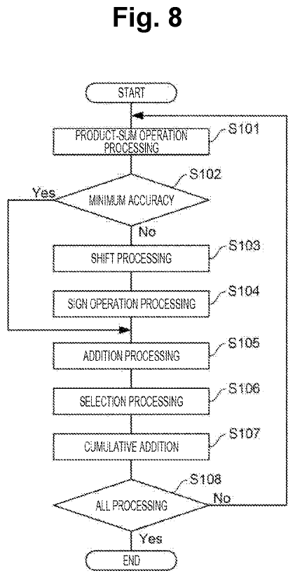

FIG. 8 is a flowchart illustrating a flow of data processing by the data processing device 10. Data processing is performed by the CPU 11 reading a data processing program from the ROM 12 or the storage 14, developing the data processing program in the RAM 13, and executing the data processing program.

In step S101, the CPU 11 performs product-sum operation processing of iFmap and kernel according to the value of M, that is, according to the operation accuracy.

After performing the product-sum operation processing in step S101, the CPU 11 subsequently determines whether or not the current processing has the minimum accuracy in step S102. The CPU 11 may determine whether or not the current processing has the minimum accuracy based on the content of the mode selection signal set from external software or the like.

As a result of the determination in step S102, when the current processing is not the minimum accuracy (step S102; No), then in step S103, the CPU 11 performs shift processing on the result of the product-sum operation processing. For example, when the minimum bit is 8 bits and the current processing is in the 16-bit mode, the CPU 11 performs shift to the left on 8 bits of high-order data of iFmap and kernel as described above. Subsequently, in step S104, the CPU 11 operates a sign. Specifically, in a case where the operation is not the operation with the minimum accuracy. the CPU 11 performs an xnor operation on the highest-order sign bit of iCH and the highest-order sign bit of kernel to operate the sign.

On the other hand, as a result of the determination in step S102, when the current processing has the minimum accuracy (step S102; Yes), the CPU 11 skips the processing of steps S103 and S104.

Subsequently, in step S105, the CPU 11 performs addition processing on the result of the product-sum operation processing or the result of the shift processing.

Subsequently, in step S106, the CPU 11 performs selection processing in the selector 105 according to the value of M, that is, according to the operation accuracy. Specifically, the selector 105 selects the output according to the mode selected based on the mode selection signal.

Subsequently, in step S107, the CPU 11 performs cumulative addition processing on the result selected in step S106. Specifically, the CPU 11 cumulatively adds oFmap in the middle of being obtained in the process of the convolution operation, and stores the oFmap in the cumulative storage memory 107. The cumulative storage memory 107 stores the cumulatively added oFmap.

Subsequently, in step S108, the CPU 11 determines whether or not processing has been performed for all iFmaps and kernels. When the processing has not been completed for all iFmaps and kernels (step S108; No), the CPU 11 returns to step S101 to perform processing on the next iFmap and kernel. When the processing has been completed for all iFmaps and kernels (step S108; Yes), the CPU 11 ends the series of processing.

By executing a series of processing, the data processing device 10 according to the present embodiment can minimize circuit resources while maximizing the product-sum operator utilization efficiency inside hardware.

### Second Embodiment

In the first embodiment, an example of convolution operation processing of iFmap and kernel with the same bit number accuracy has been described. In a second embodiment, an example in which iFmap and kernel perform the convolution operation with different bit number accuracy will be described.

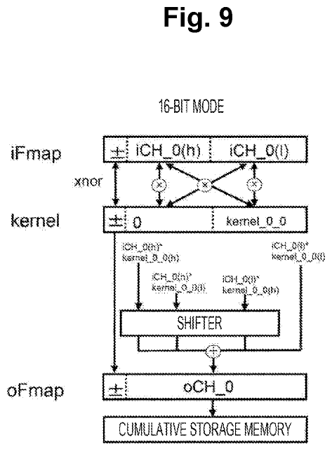

The basic configuration is the same as that of the first embodiment, but in the case of processing data with different accuracy, processing is performed according to a processing method with high accuracy. FIG. 9 is a diagram illustrating a data processing method according to the second embodiment of the present disclosure. As illustrated in FIG. 9, in a case where iFmap is processed with 16 bit accuracy and kernel is processed with 8 bit accuracy, the processing in the 16-bit mode of the first embodiment is applied. The 8 high-order bits part of kernel is filled with 0, the rest is subjected to the same processing as the processing in the 16-bit mode of the first embodiment, and accordingly, the convolution operation of the 16 bit iFmap and the 8 bit kernel is realized.

The data processing device 10 according to the present embodiment can minimize circuit resources while maximizing the product-sum operator utilization efficiency inside hardware. Furthermore, the data processing device 10 according to the present embodiment can perform convolution operation processing of data having different bit accuracy without changing the configuration from the first embodiment.

Note that the data processing executed by the CPU reading software (program) in each of the above embodiments may be executed by various processors other than the CPU. Examples of the processors in this case include a programmable logic device (PLD), a circuit configuration of which can be changed after manufacturing a field-programmable gate array (FPGA) or the like, and a dedicated electric circuit that is a processor having a circuit configuration exclusively designed for executing specific processing such as an application specific integrated circuit (ASIC). In addition, the data processing may be executed by one of these various processors, or may be executed by a combination of two or more processors of the same or different types (for example, a plurality of FPGAs and a combination of a CPU and an FPGA). More specifically, a hardware structure of the various processors is an electric circuit in which circuit elements such as semiconductor elements are combined.

In each of the above embodiments, the aspect in which the data processing program is stored (installed) in advance in the storage 14 has been described, but this is not restrictive. The program may be provided in the form of a program stored in a non-transitory storage medium such as a compact disk read only memory (CD-ROM), a digital versatile disk read only memory (DVD-ROM), or a universal serial bus (USB) memory. In addition, the program may be downloaded from an external device via a network.

Regarding the above embodiment, the following supplementary notes are further disclosed.

### (Supplementary Note 1)

A data processing device that performs a convolution operation of two pieces of input data of 2^{M}×N bits (N is a positive integer and M is a natural number) width with a minimum accuracy of the convolution operation being N bits, and performing processing corresponding to a plurality of the consecutive M, the data processing device including:
a memory, and
at least one processor connected to the memory, in which
the processor
performs product-sum operation according to the value of M,
performs shift processing on a result of the product-sum operation in a case where the value of M is not 0,
performs addition processing on a result of the shift processing or a result of the product-sum operation according to the value of M.
selects an output of the addition processing according to the value of M,
cumulatively adds the selected outputs, and
stores a result of the cumulative addition in a process of a convolution operation.

### (Supplementary Note 2)

A non-transitory storage medium that stores a computer-executable program for execute data processing of performing a convolution operation of two pieces of input data of 2M×N bits (N is a positive integer and M is a natural number) width with a minimum accuracy of the convolution operation being N bits, and performing processing corresponding to a plurality of the consecutive M, in which
the data processing includes
performing a product-sum operation according to the value of M,
performing shift processing on a result of the product-sum operation in a case where the value of M is not 0.
performing addition processing on a result of the shift processing or a result of the product-sum operation according to the value of M,
selecting an output of the addition processing according to the value of M,
cumulatively adding the selected outputs, and
storing a result of the cumulative addition in a process of a convolution operation.

### REFERENCE SIGNS LIST

10 Data processing device
101 Product-sum operation unit
102 Shifter
103 Addition unit
104 Sign operation unit
105 Selector
106 Cumulative addition unit
107 Cumulative storage memory

1. A data processing device that performs a convolution operation of two pieces of input data of 2^{M}×N bits (N is a positive integer and M is a natural number) width with a minimum accuracy of the convolution operation being N bits, and performing processing corresponding to a plurality of the data processing device comprising:
a memory; and
at least one processor connected to the memory, in which the processor:
performs product-sum operation according of M,
performs shift processing on a result of the product-sum operation in a ease where the value of M is not 0,
performs addition processing on a result of the shift processing or a result of the product-sum operation according to the value of M,
selects an output of the addition processing according to the value of M,
cumulatively adds the selected outputs, and
stores a result of the cumulative addition in a process of a convolution operation.

2. The data processing device according to claim 1, wherein the processor performs addition processing on an output of the shifter in a case where operation accuracy of the processor is not minimum accuracy, and a result of a product-sum operation of the processor in a case where operation accuracy of the processor is minimum accuracy.

3. The data processing device according to claim 1, wherein the processor further performs a sign operation by a convolution operation of the input data in a case where the value of M is not 0.

4. The data processing device according to claim 1, wherein the processor performs a product-sum operation according to a larger data width when the data widths of the input data are different.

5. The data processing device according to any one of claims 1 to 4, wherein the processor changes operations based on a mode selection signal indicating the value of M.

6. A data processing method for performing a convolution operation of two pieces of input data of 2^{M}×N bits (N is a positive integer and M is a natural number) width with a minimum accuracy of the convolution operation being N bits, and performing processing corresponding to a plurality of the consecutive M, in which a computer executes processing of
performing a product-sum operation according to the value of M,
performing shift processing on a result of the product-sum operation in a case where the value of M is not 0,
performing addition processing on a result of the shift processing or a result of the product-sum operation according to the value of M,
selecting an output of the addition processing according to the value of M,
cumulatively adding the selected outputs, and
storing a result of the cumulative addition in a process of a convolution operation.

7. A non-transitory storage medium that stores a computer-executable program for executing data processing of performing a convolution operation of two pieces of input data of 2^{M}×N bits (N is a positive integer and M is a natural number) width with a minimum accuracy of the convolution operation being N bits, and performing processing corresponding to a plurality of the consecutive M, in which
the data processing includes:
performing a product-sum operation according to the value of M,
performing shift processing on a result of the product-sum operation in a case where the value of M is not 0,
performing addition processing on a result of the shift processing or a result of the product-sum operation according to the value of M,
selecting an output of the addition processing according to the value of M,
cumulatively adding the selected outputs, and
storing a result of the cumulative addition in a process of a convolution operation.
